(19) United States
(12) Patent Application Publication
(10) Pub. No.: US 2015/0120414 A1
(43) Pub. Date: Apr. 30, 2015

(54) METHOD AND SYSTEM FOR ON-LINE SALE OF GOODS AND SERVICES USING INFLUENCER HOSTING SITES

(71) Applicant: Small Potatoes Urban Delivery Inc., Vancouver (CA)

(72) Inventors: Peter Mark David van Stolk, North Vancouver (CA); Ernest Juan Alexander von Rosen, Burnaby (CA); Mahmood Mohazzab Lighvani, North Vancouver (CA)

(21) Appl. No.: 14/395,404

(22) PCT Filed: Apr. 18, 2013
(86) PCT No.: PCT/CA2013/000384

§ 371 Date: Oct. 17, 2014

Related U.S. Application Data
(60) Provisional application No. 61/635,832, filed on Apr. 19, 2012.

(51) Int. Cl. G06Q 30/06; G06Q 30/02

(52) U.S. Cl. CPC G06Q 30/0617; G06Q 30/0214
USPC 705/14.16

(57) ABSTRACT

A method is provided for on-line retail sales by a merchant through referrals from people who have influence over customer buying decisions, such as doctors in the case of food products, and who has an internet web site. The method involves each influencer including a sub-site of the influencer's website which permits a customer to select products for purchase. The products which are available are selected by the influencer from those available in the merchant's product list. Once the customer selects products for purchase the customer is transferred to the merchant's e-commerce site for ordering, payment and delivery. The merchant rewards the influencer for purchases of the merchant's products made through the influencer's web site.

### CROSS REFERENCE TO RELATED APPLICATION

The present application claims the benefits, under 35 U.S.C. §119(e), of U.S. Provisional Application Ser. No. 61/635,832 filed Apr. 19, 2012 entitled “Method and System for On-Line Sale of Goods and Services Using Influencer Hosting Sites” which is incorporated herein by this reference

### TECHNICAL FIELD

The invention relates to Internet-based retail sales, and more particularly to a method and system for online sale of goods and services over the Internet by referral.

### BACKGROUND

Online purchase of goods and services over the World Wide Web has become an important channel for selling goods and services. While non-perishable goods such as books were the first to be widely sold online through online merchants such as Amazon.com, online sale of grocery items including fresh foods and perishable items for local delivery to the purchaser was initially made popular by such grocery delivery sites as www.webvan.com, and www.homegrocer.com and more recently www.spud.com. These sites have permitted customers to order and pay for a selection of grocery items for home or office delivery whether at pre-selected delivery times or a drop-and-go delivery left at the customer's door, with payment made either online or offline by the customer at the door.

Various methods have been developed by online merchants to increase sales by increasing traffic to their websites. One of these methods which has been used with considerable success by Amazon.com is disclosed in U.S. Pat. No. 6,029,141 entitled “Internet-Based Customer Referral System”. In that method, an online merchant such as Amazon.com enlists “associates” who receive compensation for referring customers to the online merchant's website when such customers purchase from the online merchant's website. This is done typically through a website operated by the associate and which provides a link to particular items to purchase from the merchant's website. In that method, the consumer's purchasing activity is done completely at the merchant web site.

Another form of referral marketing over the Internet is disclosed in United States patent application Publication no. 2009/0182637 entitled “Method of Referral Marketing” wherein a shopper refers another shopper to a merchant website. The merchant emails the referred shopper a discount coupon and when the referred shopper makes a purchase with the coupon the merchant sends the original shopper an incentive reward coupon.

For certain types of products, such as food, a consumer may give strong weight to, and be strongly influenced by, a recommendation from a particular professional, such as a doctor, nutritionist, naturopath, physiotherapist, fitness trainer, bloggers on the topic, food networks etc. Such individuals or sources who influence consumers' product choices are referred to herein as “influencers”. There is therefore a need for an online system which can utilize the power of influencers' referrals to increase online sales.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention therefore provides a method and system of on-line retail sales by a merchant through influencer referrals comprising: a) providing an e-commerce server for the merchant capable of conducting electronic commerce transactions, the e-commerce server being adapted to maintain a database and provide to a customer the ability to order, pay for and receive delivery of products or services from a pre-determined list of products and services maintained in the merchant's inventory; b) the merchant providing a system for enlisting and registering influencers, each influencer having a website accessible to customers of the influencer on the Internet via a plurality of client computer terminals and being provided with a unique influencer code identifier; c) the merchant providing a system for each influencer to include in the influencer's website a sub-site to permit online selection of products for purchase by a customer, and to transfer said customer to said e-commerce server for ordering and payment for selected products and subsequent delivery of said selected products from the merchant; d) the merchant providing a system for the influencer to select from the merchant website products from the merchant's inventory to be offered on the influencer's sub-site of the influencer website; e) whereby the merchant rewards the influencer for purchases of merchant's products made in association with the influencer's unique code identifier.

According to one aspect of the invention the products sold by the method are perishable food products.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating a computer network for carrying out the invention.

FIG. 2 is a simplified schematic diagram illustrating one embodiment of a system for carrying out the invention.

FIG. 3 is a detailed schematic diagram illustrating one embodiment of a system for carrying out the invention.

FIG. 4 is a web page from the influencer's website illustrating the method of the invention.

FIG. 5 is a web page showing a control panel to set up an influencer account and design a mini-site.

FIG. 6 is an online recipe page for use in the method of the invention.

FIG. 7 is a simplified schematic diagram illustrating one embodiment of a system for selecting ingredients from recipes for purchase.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The following description describes the application of the invention to the online sale of food, but it will be apparent to those skilled in the art that the invention is equally applicable to the online sale of any other goods and services where a purchaser will follow the recommendation of an influencer, for example, sporting goods, clothing, jewellery, books, music and musical instruments, gardening supplies, home improvement products, etc.

The term “web site” used herein includes both web sites in the usual sense and individual and company pages on social media or similar sites such as Facebook™ as well as pages contained or displayed on blogs. The term “products” includes both products and services.

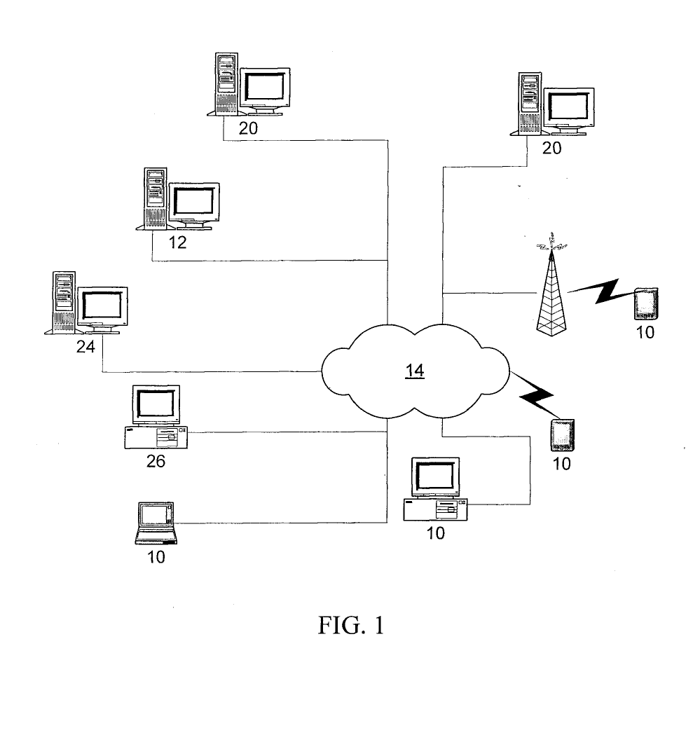

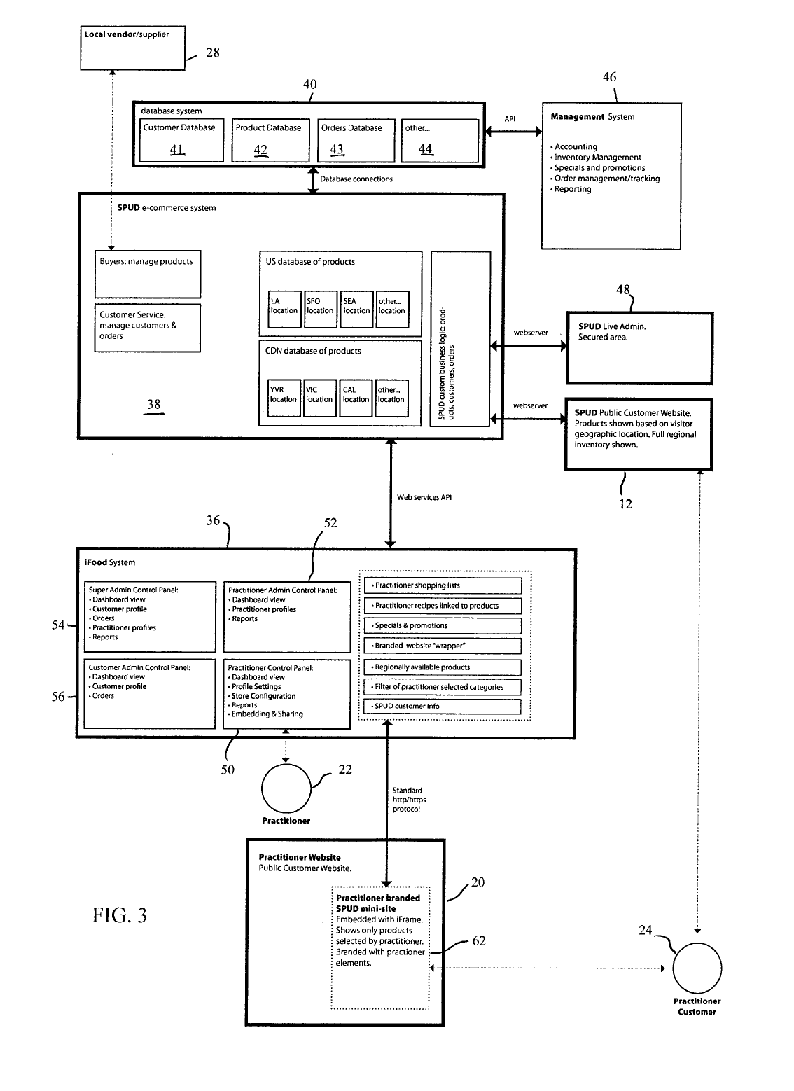

With reference to FIG. 1, one or more users have access to the Internet 14 via remote client computer terminals 10, whether desktop, laptop, wireless, wired, smartphone, tablet etc. using Internet browser software. The merchant website is hosted on web server 12 accessible to the Internet. A user at terminal 10 accesses the website 12 by pointing his or her browser at the merchant website URL. Servers 20 host websites of professional influencers such as doctors, nutritionists, naturopaths, physiotherapists, fitness trainers, chefs and the like. A telecommunication connection is also established with bank or other financial computers 26 to carry out electronic commerce transactions. Database storage for the various servers may be housed separately (see FIG. 3).

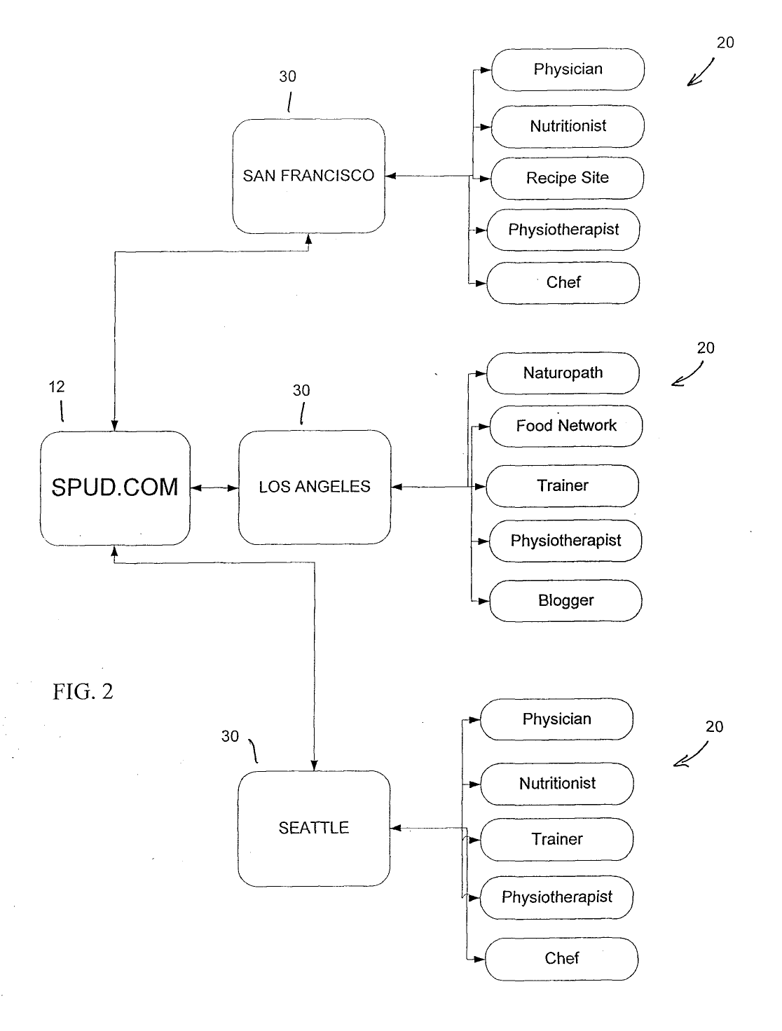

As illustrated in FIG. 2, a food/grocery merchant called Spud.com has merchant servers 30 for handling local markets, for example in 3 cities as shown, each communicating with the central Spud.com server 12 and with influencer websites 20. In each local market, the merchant enters into fixed term contracts with local food choice influencers such as doctors, nutritionists, naturopaths, physiotherapists, fitness trainers or chefs. The terms of the agreement may include the following:
influencer will have, or will establish, a personal website, which could include a Facebook™ page or other social media page or equivalent;
influencer will include as a subsite on such personal website a customized version of the merchant's e-commerce site;
the influencer's e-commerce subsite will be linked to the merchant's e-commerce platform and order filling and delivery system;
influencer will receive a fee or other compensation for each purchase made of merchant's goods through influencer's site;
merchant will handle customer satisfaction issues such as returns, refunds.

FIG. 3 illustrates schematically the various components of the system. Having entered into the contractual relationship with the merchant and set up his/her website 20, the influencer 22 sets up the e-commerce subsite (referred to herein as “mini-sites”) by accessing the merchant's influencer administration site 36 for creating and maintaining the hosted mini-sites 62. Administration site 36 is referred to in FIG. 3 as the iFood System 36 in the case of the grocery delivery example, and is accessible by the site's URL over the Internet. An enlisted influencer is assigned a username, and password to access his/her account which provides access to a dashboard control panel 50 at which the influencer can: i) set his/her profile; ii) configure the desired appearance or format of the store on mini-site 60; iii) obtain sales reports and accounting; iv) establish the parameters for embedding the mini-site in the influencer site 20 and select the parameters for sharing. A unique influencer identifier code may also be assigned for tracking referral rewards and reporting on purchases.

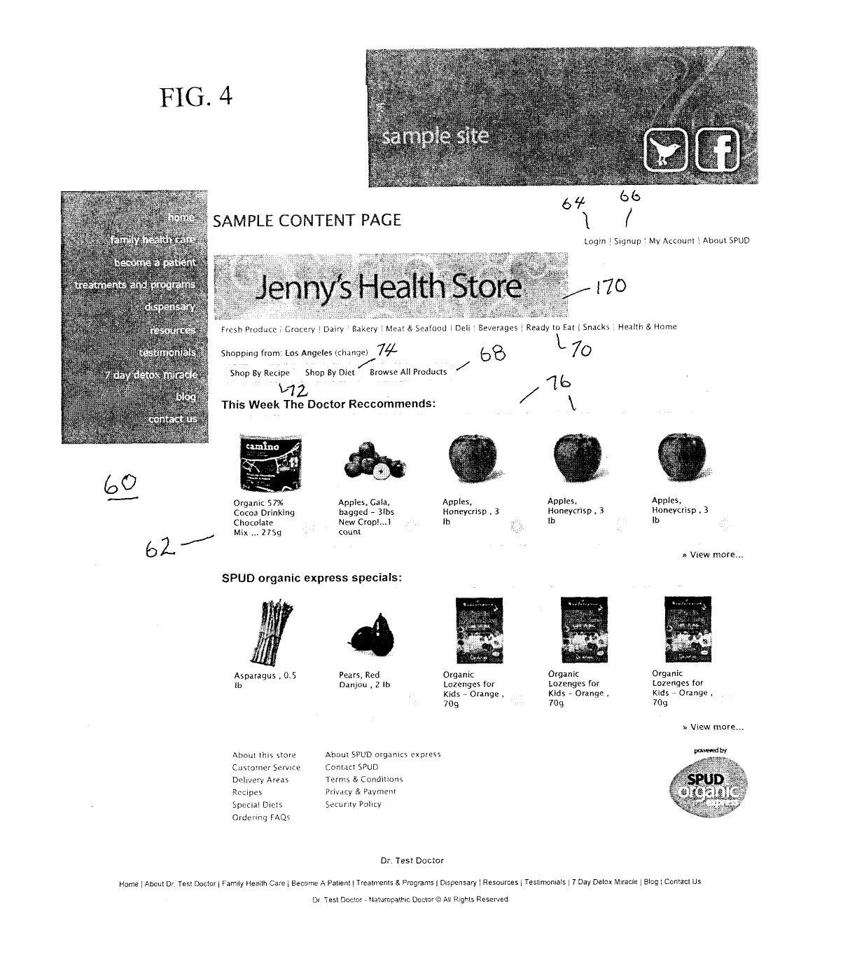

The influencer or his/her webmaster sets the features of the embedded mini-site 62 by accessing the influencer's control panel 50. For example the control panel 50 may permit the influencer to set the dimensions of the iFrame which will present the merchant's mini-site 62 on the influencer's site, and set the quality of definition and format of the store. This can be done by permitting the influencer to upload a CSS file (Cascading Style Sheet file). The control panel 50 may also permit the influencer to upload header and footer images, logo image and background image. The influencer can thereby add to the embedded mini-site a branded “wrapper” such as shown by reference numeral 170 in FIG. 4. The influencer can also enter an Embed Code to permit the mini-store to be embedded in the influencer's web site and set a sharing option to direct customers on a social network to the influencer's website or to a featured product. The influencer or his/her webmaster creates shortened URLs which can be used in other channels such as social media sites and email to link to the influencer's website or to a featured product.

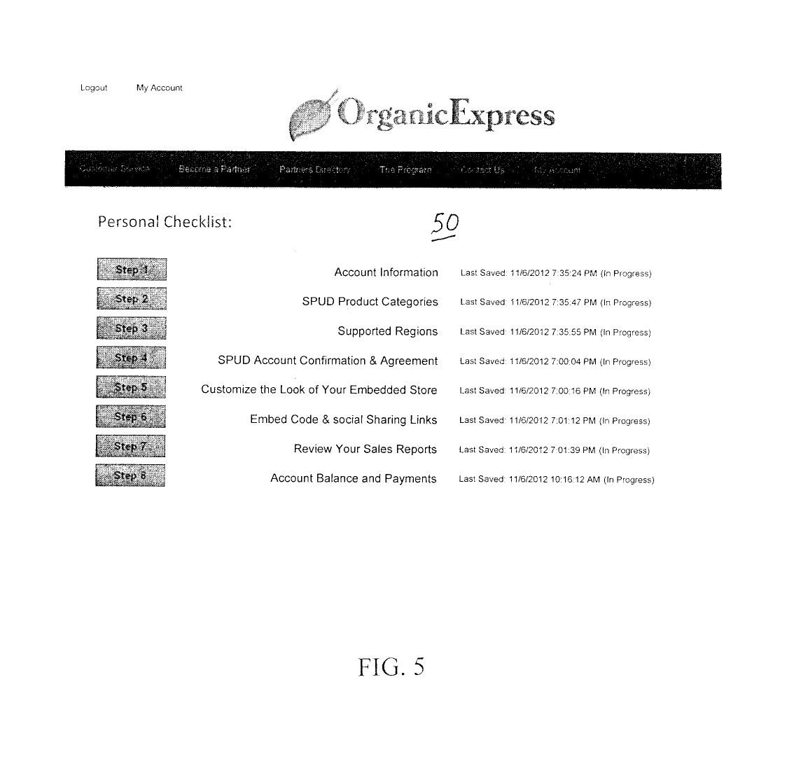

A screen shot of a sample influencer control panel 50 is shown in FIG. 5. By accessing control panel 50, the influencer can customize its mini-site 62 to insure that only products endorsed by the influencer are included for sale on its mini-site. The influencer can set up a filter which prevents certain categories of products from being listed on the mini-site, such as Frozen Products, Dessert Sauces and Baking Goods for example. The influencer can create customized shopping lists which can then be accessed and selected by the influencer's customers on the mini-site 62 (for example, by recipe, or by diet). The influencer can include special recipes that are linked to specific products, can specify that the mini-site will include alerts to merchant's specials and promotions, and can select that the mini-site 62 will display products that are only available in the influencer's region. Information concerning the influencer's customers is also maintained on site 36 for access by the influencer 22. The mini-site 62 is then constructed from the profile created by the influencer by building the embed code. Using standard http/https protocol the mini-site 62 is then embedded into the influencer's site 20 using standard iFrame methods which can be executed simply by the webmaster or influencer.

Similarly the system administrator can access i) control panel 52 to view or modify influencer profiles and obtain reports on influencer sales and activity; ii) control panel 56 to view or modify profiles of customers of the merchant (both direct and customers purchasing through the influencer) and obtain reports on customer orders; and iii) super administration control panel 54 to view or modify all of the foregoing information.

The merchant's e-commerce server 38 operates the e-commerce backbone for the influencer mini-sites 62 as well as the merchant's retail website 12. It communicates via data connections with a database system 40 which includes a customer database 41, product database 42, orders database 43 and other stored data. A management system 46 is able to access database 40 by means of an Application Programming Interface in order to carry out accounting, inventory management, order management and tracking and reporting. E-commerce server 38 also manages the ordering and payment of local suppliers and manages customer information and orders. An administration site 48 is made available on a secured access basis to display information from the e-commerce server to qualified administration personnel.

Each e-commerce transaction may for example follow two steps: the first part, via the iFrame, will be directly on the influencer's website 20 where the visitor can assemble a shopping cart and browse lists, categories, etc. But once the checkout process happens, the visitor will be moved directly to the merchant website 12 in full-page secure sockets layer (SSL) view. One of the main reasons is that in order to make it a secure transaction the full page, in SSL mode, needs to be served up from the website 12 where the money is collected.

Products of the merchant are sold to customer 24 of influencer 22 as follows. The customer 24 of the influencer will have addressed his/her browser to the influencer website 20 to obtain information and is displayed a web page 60 (FIG. 4). FIG. 4 illustrates the web page 60 which is displayed to the customer 24 when website 20 is accessed by the customer's browser. It includes the e-commerce mini-site 62, which provides a link 64 to a login page for registered users where the customer is displayed a sign-in screen and enters a user name and password if previously registered with the merchant's online site. The system thereby recognizes customers who have previously signed up with the merchant. New customers who sign up on the influencer's mini-site will be able to access their account directly also at the merchant's site, and access will be available through the OpenID platform. Link 66 to a sign-up page for new customers permits a new customer to register with the merchant by name and address, select a delivery area, contact information and be provided a user name and password and enter credit card information for one-click payment. Link 68 to a shopping page takes the customer to a product search and selection section, or links 70 permit the customer to view only items in that category. There may be a link 72 to recipes and 74 to special diets which in turn guide the customer through product selection. Special product offerings 76 may be displayed directly on the opening mini-site page 62.

Product selection and purchase for delivery at mini-site 62 can also be done in any conventional manner. A customer may first create a shopping list prior to initiating the shopping process. Clicking on a pull-down menu may give the customer a choice of preparing a new shopping list, or retrieving a previously saved list from another file or a previous order. Once the shopping list has been finalized, the shopper proceeds to the product selection step. Or the shopper may click on one of the product types displayed or in the shopping list to select a product for purchase. This causes a search of the database to be conducted for all product brands which the influencer has included having that search term and the located product brands are displayed in a product selection window. An image of each particular brand available under the selected product type is shown with the product trademark or brand, generic description, size and price. The customer can then select the desired quantity and add the item to the customer's shopping cart in the usual way by clicking on an “Add to Cart” button.

A search capability can also be provided whereby a customer can search for particular product types where the shopper wishes to look for specific products rather than work from a shopping list. The shopper can enter a product type in a search box. The server then searches for the term and if it locates a corresponding term in the database, displays the influencer's chosen brands or products which are listed in the database. The shopper can then select one of the specific product brands for purchase by clicking on an “Add to Cart” button.

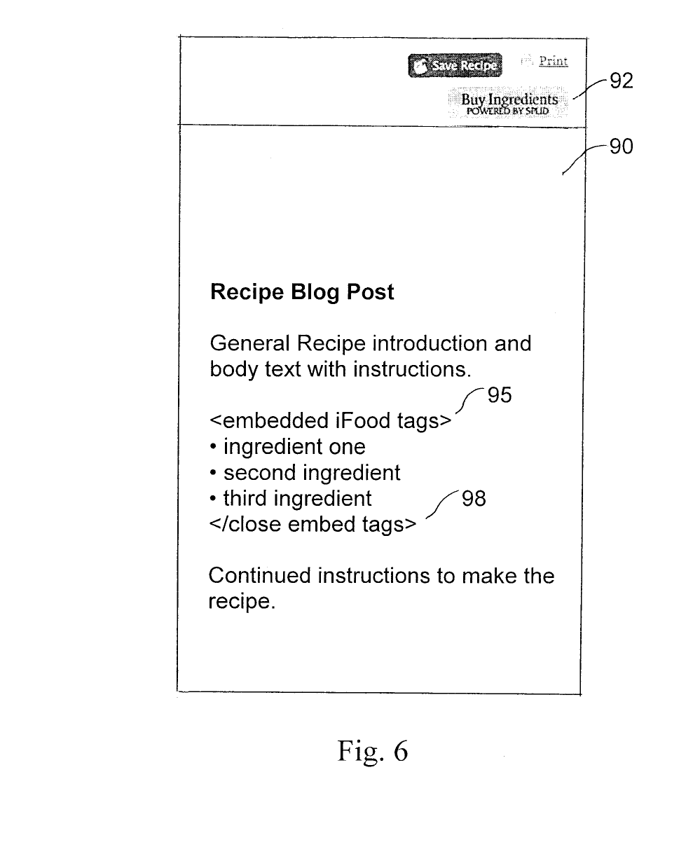

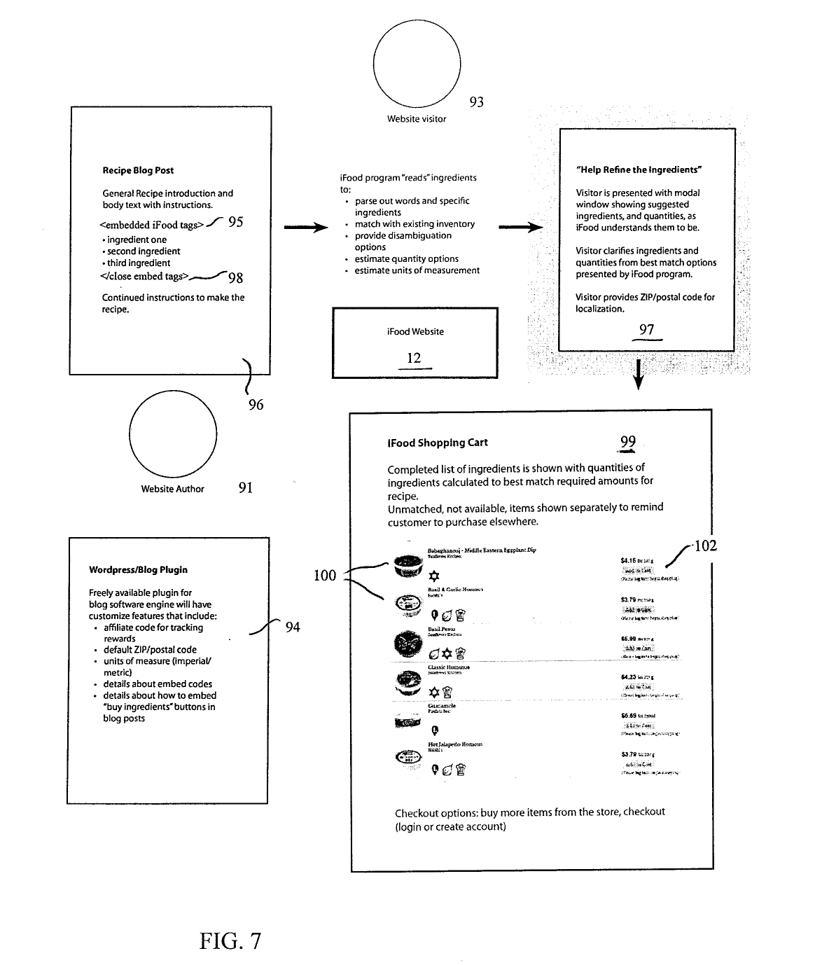

Alternate methods of product selection may be provided for example, with reference to FIG. 7, when the influencer is a blog author 91 or when an influencer's site displays recipes, as shown in FIGS. 6 and 7. In these cases a “Buy Ingredients” button 92 may be embedded in the blog text or displayed on each recipe 90. In the case of a blog author, a plugin 94 collects the following setup variables from the blog author:

i) their influencer code identifier (for referral rewards and tracking);
ii) the default ZIP/postal code they would like to define for local product selection;
iii) top-level category selection (in the case of food, for example, if the author wants to block out certain food categories);
iv) Imperial or metric system of units of measurement;
v) details about how to embed the “Buy Ingredients” button on their site posts;
vi) details on how to embed proprietary <tags> 95, 98 to indicate where the ingredients are listed in the blog post.

The author then can distinctly indicate the ingredients section of any blog post with Wordpress' starting <tags> 95 and ending </tags> 98.

When a website visitor 93 reads a blog post that includes a recipe that has been appropriately tagged, as described above, they will be presented with a “Buy Ingredients” button 92. Upon clicking that button the following procedures happen:

i) the “Buy Ingredients” button, will pass the ingredients text copy to the iFood website 12;
ii) the iFood website 12 will parse the information to identify ingredients with the use of keyword matching. The program also identifies units and quantities of measurement for ingredients. The parsing program is heuristic i.e. designed to learn over time to provide better disambiguation and recommendation options.
iii) the website visitor 93 then sees a “modal window” 97 (a smaller screen that floats above the original blog post which is also greyed out). This window presents the list of ingredients, units of measure and quantities as it best understands them. Disambiguation is then provided for with the use of suggested items or recommended alternatives (for example “did you mean . . . ”?). The visitor can then view the original text, with interpreted ingredient text, and make necessary adjustments. The visitor also provides a ZIP/postal code to indicate where they are shopping from.
iv) a “proceed to cart” button moves the visitor 93 to the next page 99. In the final shopping cart review page 99, still in a modal window floating over the original blog post, the customer 93 can see the final list of selected products 100, quantities and pricing which can be added to the shopping cart by clicking on an “Add to Cart” button 102. The visitor can still at this point make unit adjustments, continue shopping to add more items, or checkout. The checkout pushes the visitor to the merchant e-commerce site 38 where they checkout in a secure SSL format as described further below.

A “screen scraping” method is a second method which would essentially function the same as the above mentioned procedure. The difference is that this system would be more comprehensive in interpreting the ingredients list and would not require the blog post editor to specifically mark out the ingredients lists in their posts. The program reads the whole page and identifies the ingredients list, therefore requiring an improved intelligence in the programming language. This would permit the influencer, in the initial construction of the mini-site 62, to upload recipes which will be scanned by the server 36, a list of ingredients created and linked to a “Buy Ingredients” button 92 on the recipe for display on the influencer's site 20. Also while the foregoing describes application of the method to food recipes, it would be applicable to other types of products. For example a music reviewer may include a list of musical recordings of interest on a particular topic which might similarly be automatically selected for purchase.

Once the customer has added all the desired items to the shopping cart, the customer clicks on a “proceed to check-out” link which then transfers the customer to the merchant's e-commerce site 38. If not already signed in, the customer is prompted to sign in by username and password. If not already registered with the merchant, the customer may be prompted to fill out customer profile and payment information, by entering name, address, selecting a username and password and providing credit card information. Delivery address information may also be provided. The customer then signs in and is served up the check-out screen which has been filled in with the previous product selection from the shopping cart. The influencer code identifier is also associated with the transaction. The customer may then confirm delivery addresses and selects or is assigned a delivery time. Once that information is complete and the customer selects the “check-out”, the order is processed for payment and delivery. The customer may pay for the goods by credit card at the site 62 or the system may permit that actual payment for the groceries may be made in person to the delivery person at time of delivery of the groceries. In that case the credit card information may still be necessary as security in case a customer orders a delivery time but is not available to accept delivery.

The purchase is recorded to an account connected to the influencer code identifier for purposes of referral rewards and tracking of quantities and types of purchases for preparing reports for the influencer. The influencer can thus monitor and alter the selection of the merchant's goods which it has selected for sale on the mini-site 62.

Thus the influencer's customer's purchasing experience is completely within the influencer's site. However the processing of the payment, order and delivery are communicated through the administration site 36 to the merchant's e-commerce site 38 via web services Application Programming Interface.

The present invention therefore allows a merchant, such as an online grocer, to build a network of influencers and create the business value of such a network. A large network of influencers has significant social network value, in the same way as Facebook™. Once such a network of influencers has been built for the merchant, there will be an opportunity to introduce additional products and services to be distributed via the network. The system also provides value to the influencers not only in additional revenue but also in giving their customers added services which attract customers more frequently to their site which will result in increased business in other areas. In the case of perishable products, for example, the influencer can offer an inventory of products to its customer which would not otherwise be possible.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true spirit and scope. For example while the application of the invention has been described in the context of influencer web sites in the usual sense, the same method is applicable to individual influencer and company influencer pages on social media or similar sites such as Facebook™.

What is claimed is:

1. A method of on-line retail sales by a merchant through influencer referrals comprising: a) providing an e-commerce server for the merchant capable of conducting electronic commerce transactions, said e-commerce server being adapted to maintain a database and provide to a customer the ability to order, pay for and receive delivery of products from a pre-determined list of products maintained in said merchant's inventory; b) said merchant providing a system for enlisting and registering influencers, each influencer having a website accessible to customers of the influencer on the Internet via a plurality of client computer terminals and being provided with a unique influencer code identifier; c) said merchant providing a system for each said influencer to include in the influencer's website a sub-site to permit online selection of products for purchase by a customer, and to transfer said customer to said e-commerce server for ordering and payment for selected products and subsequent delivery of said selected products from the merchant; d) said merchant providing a system for said influencer to select from the merchant website products from the merchant's inventory to be offered on the influencer's sub-site of said influencer website; and e) whereby said merchant rewards said influencer for purchases of merchant's products made in association with said influencer's unique code identifier.

2. The method of claim 1 wherein a customer of the influencer assembles a selection of products for purchase on said sub-site of the influencer's website and for the checkout and payment process is transferred to said merchant's e-commerce server.

3. The method of claim 2 wherein said step of assembling a purchase is carried out by the customer selecting items from lists of said merchant's products and adding them to an on-line shopping cart.

4. The method of claim 2 wherein said sub-site of said influencer's website comprises a selected list of said merchant's products and said step of assembling a purchase is carried out by the customer selecting items from said selected list of said merchant's products and adding them to an on-line shopping cart.

5. The method of claim 2 wherein said step of assembling a purchase is carried out by the customer electing to buy a list of items embedded in an online document.

6. The method of claim 1 wherein said merchant's products are grocery products.

7. The method of claim 6 wherein said step of assembling a purchase is carried out by the customer electing to buy a list of items embedded in an online document.

8. The method of claim 6 wherein said influencer is selected from the group consisting of doctors, nutritionists, naturopaths, physiotherapists, fitness trainers and chefs.

9. The method of claim 1 wherein said merchant's products are selected from the group consisting of sporting goods, clothing, jewellery, books, music and musical instruments, gardening supplies and home improvement products.

10. A computer-implemented system for on-line retail sales by a merchant through influencer referrals, wherein a plurality of individuals are linked by an interactive computer network accessible to said plurality of individuals by means of said computer network, said computer network comprising:
a) an e-commerce server for the merchant capable of conducting electronic commerce transactions said e-commerce server comprising a computer processor, said computer processor further comprising computer programming code which, when executed maintains a database and provides to a customer the ability to order, pay for and receive delivery of products from a pre-determined list of products maintained in said merchant's inventory;
b) a web server for hosting a web site for administering the merchant's influencers, said web server comprising a computer processor, said computer processor further comprising computer programming code which, when executed maintains registration of influencers, assigns each influencer a unique influencer code identifier and generates code for each said influencer to include in the influencer's website a sub-site to permit online selection of said merchant's products, for said influencer to select from the merchant website products from the merchant's inventory to be offered on the influencer's sub-site of said influencer website and transfer a customer to said merchant's e-commerce server for enabling ordering and payment for products and subsequent delivery of products from the merchant, and for rewarding said influencer for purchases of merchant's products made in association with said influencer's unique code identifier;
b) a web server for hosting web sites of influencers accessible to customers of the influencers on the Internet via a plurality of client computer terminals; and
c) a database for data storage.
